(19) United States
(12) Patent Application Publication
(10) Pub. No.: US 2020/0311245 A1
(43) Pub. Date: Oct. 1, 2020

(54) AUTHENTICATING OBJECT INSTANCES

(71) Applicant: Hewlett-Packard Development Company, L.P., Spring, TX (US)

(72) Inventors: Stephen Pollard, Bristol (GB); Faisal Azhar, Bristol (GB); Guy Adams, Bristol (GB); Steven J. Simske, Fort Collins, CO (US)

(73) Assignee: Hewlett-Packard Development Company, L.P., Spring, TX (US)

(21) Appl. No.: 16/754,397

(22) PCT Filed: Oct. 30, 2017
(86) PCT No.: PCT/US2017/058969

§ 371 Date: Apr. 8, 2020

(51) Int. Cl. G06F 21/44; G06K 7/14

(52) U.S. Cl. CPC G06F 21/44; G06F 2221/2145; G06F 2221/2111; G06K 7/1417

(57) ABSTRACT

A method for authenticating an instance of an object comprises transmitting an object-instance identity derived from identity data associated with an instance of the object to an object service, receiving location data from the object service representing locations of respective ones of multiple object-instance-specific virtual marks, and transmitting data derived from one or more of the virtual marks to the object service.

### BACKGROUND

A three-dimensional object may be produced using a manufacturing process. This can include an additive manufacturing or rendering process which involves generating the object on a layer-by-layer basis. Multiple three-dimensional objects may be generated to the same specification to provide multiple object instances, each of which appear substantially the same. It may be intended to identify each object, for example to authenticate an instance.

### BRIEF DESCRIPTION OF THE DRAWINGS

Various features of certain examples will be apparent from the detailed description which follows, taken in conjunction with the accompanying drawings, which together illustrate, by way of example only, a number of features, and wherein:

FIG. 1 is a flow chart of a method for authenticating an instance of an object according to an example;

FIG. 2 is a schematic representation of a system according to an example;

FIG. 3 is a schematic representation of a instance of an object according to an example; and

FIG. 4 is a flowchart of a method according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Additive manufacturing can be used to generate or render a three-dimensional object through the solidification of a build material. In some examples, the build material may be a powder-like granular material, which may for example be a plastic, ceramic or metal powder. Build material may be deposited, for example, on a print bed and processed layer by layer, for example, within a fabrication chamber. Other manufacturing techniques, including for example casting, injection moulding and machining may also be used to generate three-dimensional objects. In each case, such manufacturing processes have clear variation in finish due to random elements of the manufacturing process. As such, there will be an instance to instance variation in surface features that can be leveraged to enable instance authentication. Examples are described, predominantly, with reference to additive manufacturing systems, however, the method and system described herein is suitable for use with other manufacturing processes.

In an additive manufacturing system, objects may be generated based on structural design data, which can involve a designer generating a three-dimensional model of an object to be generated, for example using a computer aided design (CAD) application. The model may define the solid portions of the object. To generate a three-dimensional instance of the object using an additive rendering system, the model data can be processed to generate slices of parallel planes of the model. Each slice may define a portion of a respective layer of build material that is to be solidified or caused to coalesce by the additive rendering system.

Design data may be used by a manufacturing apparatus to generate multiple three-dimensional object instances all according to the same specification. It may be intended that each object is identifiable, such that it is possible to determine whether a particular instance is one which was generated using a particular manufacturing apparatus, or whether the instance is counterfeit.

According to an example, an instance of an object can be provided with one or more object-instance-specific virtual marks or identifiable features. A virtual mark or set of virtual marks can be used as an identifier for the instance, which can be used to authenticate the instance or otherwise attest to its provenance.

In an example, a virtual mark can be provided or present on or in a region, area or volume of an object instance such that an identifiable aspect or feature exists which may be used at some later time to identify the object instance. In some examples, the identifiable feature making up a virtual mark may comprise a physical structure, feature or characteristic of the object instance itself. For example, a particular characteristic of the build material used to generate the three-dimensional instance of the object within the region of interest may be measured and noted. In other examples, the identifiable feature may comprise a surface property (e.g. a light scattering measurement), a shape of a portion of the surface, a surface texture, a colour measurement, a chemical composition or an absorption spectrum measurement from a portion of the object instance within the region of interest.

In some examples, an object instance identity can be encoded in an identity mark or object created in or on the instance, such as a barcode, a QR code, a chemical taggant, an embedded identifier or quantum dots. According to an example, the identity of an object instance can be derived from identity data encoded in the mark or object, which can be located on the surface of an instance of the object. The mark or object can, for example, encode a serial number of the instance, which can be used to identify one or more characteristics of the object instance such as one or more of: type of object, date of manufacture, area of manufacture, expiry date and so on. One or more other forensic-quality mark can be provided to prove authenticity.

According to an example, the identity of an object instance, as derived from the identity mark or object, can be used to determine the position of one or more object-instance-specific virtual marks. In an example, each instance of an object that has been manufactured can include an identity mark or object that can be used to identify the instance. The location of the identity mark or object can be the same for every instance of an object or may vary. This identity can be mapped to the location of one or more virtual marks for the instance that can be used to authenticate the instance.

For example, a quantity measured at a region of interest defining a virtual mark of an object instance may be measured at a later time and compared with a previous measurement, such as a measurement performed at the point of manufacture, to confirm whether or not the virtual mark corresponds to that expected.

In this way, the virtual mark may be considered to be a fiducial, and may be considered to include a physical identifying feature. However, in an example, the fiducial is virtual so that the region of interest appears is not distinguishable from adjacent regions of the object instance. The identifiable feature may be a property of the object itself, such as a rendering artefact. The identifiable feature may be considered to be a fingerprint of the object. The fingerprint may be checked (e.g. extracted and compared with a corresponding fingerprint stored in a database or the cloud) to confirm its identity,

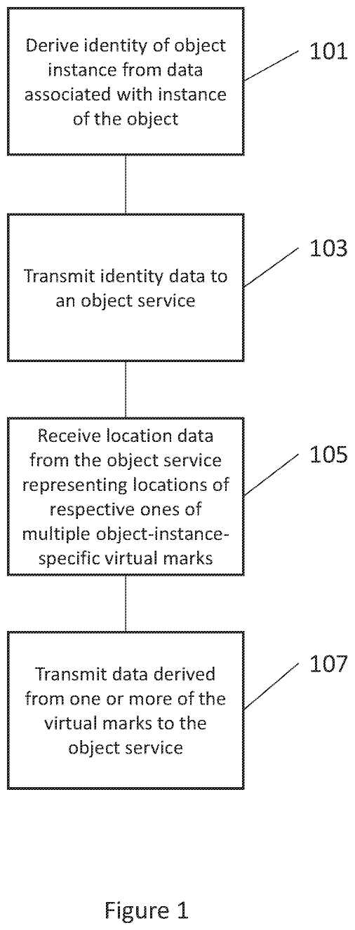

FIG. 1 is a flow chart of a method for authenticating an instance of an object according to an example. The instance can be an additively manufactured or rendered instance for example, or an instance that is manufactured using any other manufacturing process in which random elements of the manufacturing process result in variations in finish between instances. At block 101 the identity of an object-instance is derived from identity data associated with an instance of the object. For example, an identity mark or object located on the surface of the instance can be read or interrogated in order to determine the instance identity, which can be encoded on or in the mark or object and which may be provided in encrypted or unencrypted form. In the latter case, a suitable key may be provided to enable decryption of the instance identity. In an example, identity data may be encoded in an object that is embedded within the object instance. For example, an RFI© tag may be provided on the surface or just below so that it is not visible to the naked eye. In latter case, one or more registration markings may be provided in order to enable the location of the object to be determined for the purposes of interrogation. Alternatively, some RFI© objects can be read over large distances, meaning that such registration marks are not used.

In block 103, the identity data is transmitted to an object service. In an example, the object service can be a cloud based service configured to receive data representing an identity of an object instance. The object service can include a database that comprises a set of tuples that map respective object instance identities to a set of object-instance-specific virtual mark locations. That is, the database can include data that maps an object instance identity to a set of locations where one or more virtual marks may be found for the instance in question.

The object service can also include data representing the identifiable feature of a virtual mark whereby to enable a measurement from the virtual mark of an object-instance to be compared against known data representing the feature that should be present at the location in question. Accordingly, the instance can be authenticated by comparing measurements of identifiable features at various locations with data representing the identifiable features stored at the object service.

That is, according to an example, at block 105, location data can be received from the object service representing locations of respective ones of multiple object-instance-specific virtual marks. These location data vary corresponding to the specific instance as identified using the identity data.

In block 107, data derived from one or more of the virtual marks can be transmitted to the object service. This data can be used to authenticate the object instance. As described above, a comparison of the data derived from the one or more of the virtual marks can be compared with known data representing the identifiable features at the locations. If the identifiable features are the same, the instance can be considered authentic. If one or more of the identifiable features are not the same, the instance may be counterfeit. This can include the instance being intentionally fraudulent, from re-packaging to duplication, and can also imply a problem with a manufacturer, distributor, warehouse and/or retailer. In an example, a degree of tolerance may be permitted, such that an instance is considered authentic if a predefined number of comparisons result in a pass.

In an example, the location data transmitted in block 105 can include data representing only selected locations. That is, a subset of all available locations of virtual marks for an object instance can be provided. For example, if some locations are considered compromised, they can be removed from the set so that only uncompromised locations of virtual marks are used.

In an example, an identity of an object instance can include an unequivocal code that enables more information on the specific object instance to be determined from a registry. Alternatively, an identity can be a statistically forensic identity, e.g. less than 1 in 10⁻⁹ chance of a false positive reading.

Accordingly, in an example, an instance of an object, such as an additively rendered instance, includes additional information that can be used to indicate which virtual forensic marks are specifically available. For example, an additional visible barcode of some kind or an embedded RFD tag could provide information as to where a virtual forensic mark is located on the current part. This could, for example, be a direct position on the part by indication of one or more locations directly from a fixed set. Alternatively, the additional code can provide serialization data that allows for further information to be recovered from a database at the object service that is indexed by the serial number.

In an example, the serialization data can be used as a pointer to a custom webpage that then allows any variety of interactive steps between the user, the website and the object. As the specific locations of multiple virtual forensic marks can vary on an instance by instance basis, it is possible to use the object service to control which to use for a particular investigation. This could be random or determined in some way based on previous verifications. This approach would ensure that for high value items, even if a location were to be copied (e.g. by physical removal) the counterfeiter would not know which other regions were also needed. It also allows situations in which different forensics are used for different user roles, or agents, such as customer, retailer, warehouse, distributor, manufacturer, customs agent, inspector, secret shopper, etc. In an example, a role can be established by a combination of identity (e.g. biometric verification), possession (e.g. of the right mobile phone) and/or knowledge (e.g. of the right password, passphrase, etc.).

According to an example, a set of ‘n’ virtual mark locations can be separated into multiple sub-sets, one for the random selection and one or more, depending on required statistical confidence in the “proof”, reserved for legal proof (i.e. only revealed as a last resort). Furthermore, the use of multiple locations of virtual forensic marks provides resilience (redundancy) due to wear or damage.

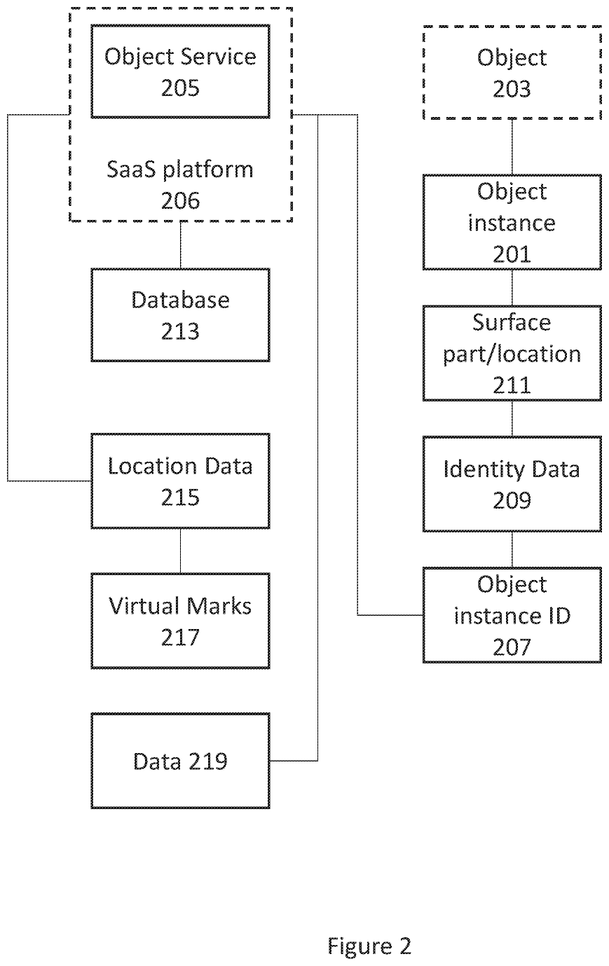

FIG. 2 is a schematic representation of a system according to an example. The system 200 can be used to authenticate an instance 201 of an object 203. In the example of FIG. 2, an object service 205 can receive an object-instance identity 207 derived from identity data 209 associated with the instance 201 of the object 203. For example, the identity data 209 can be located on a part of the surface 211 of the instance 201.

The object service can be provided as part of a cloud based SaaS 206 for example, and includes a database 213 (or is able to access a database that may be stored at another remote location). In an example, the object service can be provided as a local service (such as on user equipment for example) thereby enabling authentication of an instance without the need for a network connection.

The object service can transmit location data 215 representing locations of respective ones of multiple object-instance-specific virtual marks 217. In an example, the object service 205 can receive data 219 derived from one or more of the virtual marks 217.

The locations of the multiple virtual marks 217 can be specified at the design time for each instance 201 of the object 203. Accordingly, each instance 201 can have multiple virtual marks, the locations of which are varied on an instance by instance basis.

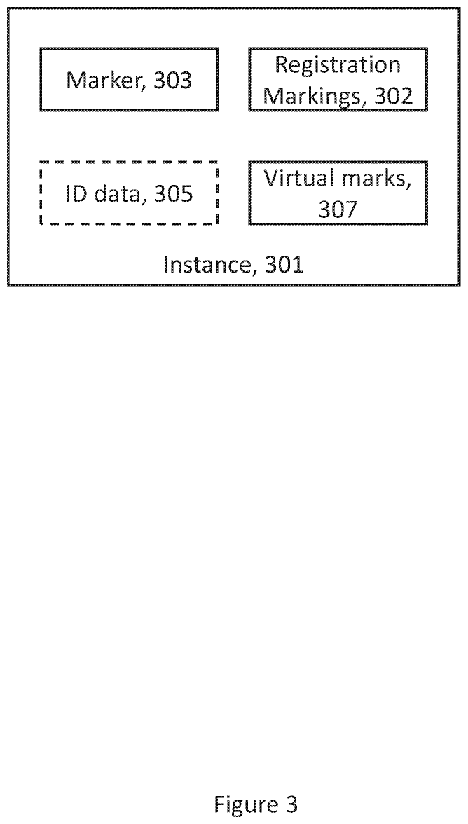

FIG. 3 is a schematic representation of an instance of an object according to an example. The instance 301 comprises a marker 303 located on or in a surface of the instance. For example, the marker 303 can be a barcode or RFID tag located on the surface of the instance 301, or an RFID tag or similar that is embedded under the surface of the instance 301. Other examples of markers 303 are described above.

In an example, marker 303 encodes identity data 305 representing an identity of the object instance 301. This may be serialisation data that identifies the specific instance 301. As described with reference to FIG. 2, the identity data 305 can be transmitted to the object service 205 where it can be mapped with the locations of one or more object-instance-specific virtual marks 307. The marks 307 are disposed over the surface of the instance 301 at these selected locations, and the locations vary on an instance by instance basis such that the location of virtual marks is different for each instance of an object.

In an example, the multiple object-instance-specific virtual marks 307 are rendering artefacts. For example, in additive manufacturing, the surface of the instance will exhibit irregularities that vary from instance to instance such that no two instances are, at the micro level (e.g. at the 1-10 microns feature size), the same. At the point of design or manufacture of an object instance, a set of surface locations can be selected, each of which determines the location of one of multiple virtual marks for the instance. As such, a virtual mark can comprise the surface structure of the instance at a preselected location. The size of each virtual mark can be a selected area, such as an area between, for example, 1 mm² to 1 cm² or more.

In an example, marker 303 can be a virtual mark located or visible at a known location on the surface of the object instance 301. That is, an initial primary virtual forensic mark can be used as a serialization feature. As this allows identification of the part itself it can be used as the key into a database that contains a list of instance specific virtual forensic marks. Hence, for each instance there can be one or more initial virtual forensics whose location is fixed for the particular model that is rendered. However, for each instance of the same object there would be a number of other virtual marks whose location would vary and for which authentication could be on a random basis. Decoding of the first mark would identify the instance and direct the subsequent authentication process.

Therefore, according to an example, additional information or serialization can be included as a visible bar code or RFID tag to uniquely identify the instance of an individual object, such as an additively rendered part for example. Instance specific locations of virtual marks can be stored in a cloud database, thus creating a two-layered secure workflow which uses the visible bar code or RFID tag to first verify the instance and then relay the locations of virtual mark. The location of virtual marks does not need to be stored as a meta-data or part of a 3D model which allows information about the locations of virtual mark to be secured in the cloud database (such as database 213 for example). The additional information can be used to store (in an encrypted form) the location of and the signature contained in the virtual mark, thus enabling local (offline) verification, and a hybrid approach of local and cloud virtual mark location and subsequent forensic verification can be used.

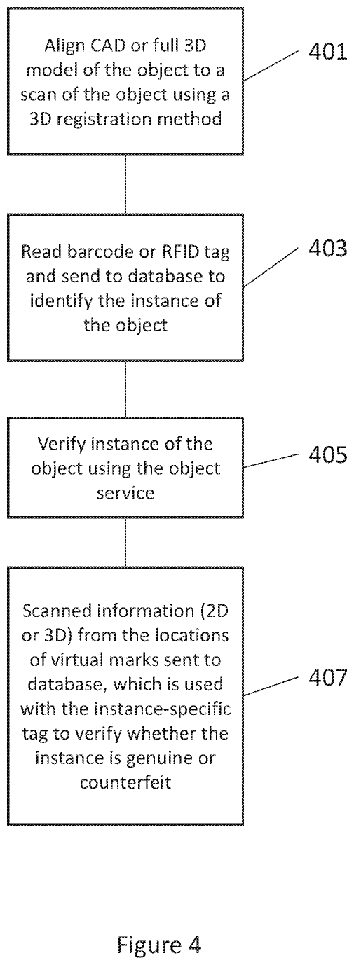

FIG. 4 is a flowchart of a method according to an example. Instance specific 3D implicit or virtual mark (fiducial) locations can be defined based on a CAD design or full 3D scan of an object. As noted above, a barcode or RFID tag can be used to associate (or map) each instance of the object to the locations of virtual mark(s) which can be stored either explicitly in the barcode or referenced in the object service using the database. In block 401, the CAD or full 3D model of the object is aligned to a scan of the instance using a 3D registration method. Subsequently, in block 403, the barcode or RFID tag is read and sent to the database to identify the instance of the object.

In block 405, the instance of the object is verified in the object service. In block 407, the instance specific virtual locations are made available to a scanning device in order to enable the data from the locations to be read or determined. For example, an imaging device can be used to determine the surface structure of the instance at the location in question for a virtual mark.

In block 407, the scanned information (2D or 3D) from the locations of virtual marks are sent back to the cloud database, which is used with the instance-specific tag to verify whether the instance is genuine or counterfeit.

In an example, each location of a virtual mark on the surface of a model of an instance can be associated with the location at which a forensic signature for the instance has been or can be extracted. It can include a position and orientation on the surface of the instance. A scanning device can be used to extract 2D or 3D information from these virtual mark locations for verifying the printed part.

A system and method provided according to an example enables cost free 3D virtual fiducial for defining the location of a forensic mark, also providing extension to multiple fiducial locations on a single 3D part for robustness to wear of a 3D part and for high value items where a single location could be mechanically transplanted. Covert authentication is possible by restricting knowledge of the whereabouts of the multiple locations.

As described above, automatic location finding at the CAD and 3D scan stages can be used. The provision of multiple virtual marks enables role-based workflows. For example, a posteriori defined workflows can be accommodated after connecting to a database and/or website.

In an example, the error between a 3D scan and a (CAD) model of the object can be used for validation, inspection, quality control and a measure of authentication. For example, if the mean squared error difference of the object surface after alignment is greater than a threshold, this step alone can be used to invalidate the object, without any need to continue onto a forensic evaluation. Additionally, the image difference(s) can itself/themselves be used as features suitable for clustering and/or classification of invalidated objects, which can allow an illicit supply chain to be reverse engineered through clustering/classification.

The additional levels of security provided therefore make it more difficult to copy an object and increase the degree of difficulty for the counterfeiter, and the part itself is used as its own fiducial. Tolerances in manufacturing can be accommodated, and multiple means of accessing the fiducial location descriptor can be provided. In an example, the additional information can be used to store locations of virtual marks and forensic signature(s) for local (offline verification), and hybrid use of local and cloud location(s) and signature(s)

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for authenticating an instance of an object, the method comprising:
transmitting an object-instance identity derived from identity data associated with an instance of the object to an object service;
receiving location data from the object service representing locations of respective ones of multiple object-instance-specific virtual marks; and
transmitting data derived from one or more of the virtual marks to the object service.

2. A method as claimed in claim 1, further comprising:
storing at least one of: the identity data, location data and data representing the object-instance-specific virtual marks at the object service.

3. A method as claimed in claim 1, further comprising:
determining the object-instance identity from one of: a virtual mark, a 2D barcode and radio-frequency identification marker, located or visible at a known location on the surface of the object instance.

4. A method as claimed in claim 1, further comprising:
using data derived from selected multiple ones of the virtual marks to authenticate the instance of the object.

5. A method as claimed in claim 1, further comprising:
defining the locations of respective ones of multiple object-instance-specific virtual marks for the object instance at design or manufacture of the object instance.

6. A method as claimed in claim 5, further comprising:
mapping the locations of respective ones of the multiple object-instance-specific virtual marks for the object instance to the object-instance identity.

7. An instance of an object, the instance comprising:
a marker associated with the instance encoding identity data representing an identity of the object instance; and
multiple object-instance-specific virtual marks.

8. An instance of an object as claimed in claim 7, wherein the identity data is encoded in a barcode or passive radio-frequency identification marker.

9. An instance of an object as claimed in claim 7, wherein the multiple object-instance-specific virtual marks are rendering artefacts on respective selected portions of the surface of the object instance.

10. An instance of an object as claimed in claim 7, wherein respective locations of the multiple object-instance-specific virtual marks are encoded in the marker.

11. An instance of an object as claimed in claim 7, wherein the marker is a virtual mark located or visible at a known location on the surface of the object instance.

12. An instance of an object as claimed in claim 7, wherein the locations of respective ones of multiple object-instance-specific virtual marks for the object instance are defined at design or manufacture of the object instance.

13. A system comprising an object service to:
map an object-instance identity derived from identity data associated with an instance of an object to data representing locations of respective ones of multiple object-instance-specific virtual marks;
authenticate the object-instance using data derived from one or more of the virtual marks and received at the object service

14. A system as claimed in claim 13, the object service further to:
transmit data representing the locations of respective ones of multiple object-instance-specific virtual marks.

15. A system as claimed in claim 13, the object service further to:
transmit location data representing locations of a subset of respective ones of multiple object-instance-specific virtual marks, whereby to enable a role-based workflow.
